(19) United States
(12) Patent Application Publication
(10) Pub. No.: US 2016/0107111 A1
(43) Pub. Date: Apr. 21, 2016

(54) METHOD AND SYSTEM FOR MANAGEMENT OF GREY WATER IN AN AIRCRAFT

(71) Applicant: MAG AEROSPACE INDUSTRIES INC, Carson, CA (US)

(72) Inventor: Razmik Boodaghians, Glendale, CA (US)

(21) Appl. No.: 14/515,314

(22) Filed: Oct. 15, 2014

(51) Int. Cl. B01D 35/26; F04B 43/04; B01D 35/02

(52) U.S. Cl. CPC B01D 35/26; B01D 35/02; F04B 43/04

(57) ABSTRACT

This invention relates to a method of draining grey water contained in a water holding tank of a system for management of grey water in aircraft toilets. According to the invention, the method consists of draining the grey water through an undulating diaphragm pump comprising an inlet conduit connected to the said holding tank; the pump diaphragm is able to undulate, by way of actuating means, between two flanges for draining the said grey water present in the holding tank through the inlet conduit of the pump to a discharge conduit of the pump.

### BACKGROUND

1. Technical Field

This invention relates to a method of draining grey water contained in a water holding tank of a grey water management system in toilets on an aircraft as well as a grey water management system in an aircraft.

2. Description of the Related Art

In the field of aeronautics in particular, vacuum toilet units are well known to be used for flushing waste into a septic tank. The water used in the vacuum toilets is usually obtained from the grey water from washbasins or the aircraft galley in order to limit the amount of water on board and finally the weight of the aircraft. The term galley refers to the special compartment of the aircraft used for the presentation of meals. Furthermore, the term “grey water” refers to the grey water containing pollutants such as domestic water from washing dishes or hands.

Thus, the grey water management system usually comprises a washbasin, a water supply valve of the said basin, a grey water drainage system of the washbasin connected to a holding tank equipped with a filter, a bowl supplied with water by a pump connected to the holding tank. The system also comprises a main grey water tank; the washbasin and the holding tank are connected to the said main tank by conduits each fitted with a valve and a solenoid valve.

The pumps used in these grey water management systems consist of rotodynamic pumps, such as turbopumps and/or positive-displacement pumps for example, operated by electric or hydraulic power.

The rotodynamic pumps that are most commonly used in grey water management systems are the turbopumps, also known as centrifugal pumps, which comprise a pump case consisting mainly of a suction pipe, a volute and a discharge nozzle. The volute receives the mobile part or rotor which consists of the impeller. The latter is in the form of a rotor mounted on a shaft. The rotor is actuated by a drive machine which can be a hydraulic or electric motor, a heat engine or a turbine.

This type of pump has many disadvantages. In general, this type of pump has poor energy efficiency, in the order of 30-70%. It is space-consuming and bulky and involves high wear of rotating parts resulting in frequent maintenance and sensitivity to cavitation. Cavitation is a noisy phenomenon, which can destroy a machine in a few minutes. When pumping, the fluid located within a centrifugal pump does not have uniform pressure. It is particularly located in areas that have more or less accentuated depressions. When the pumped liquid is sufficiently close to its boiling point, that is to say the point of transition from the liquid state to the gaseous state, it may occur that the pressure at these points falls below its steam pressure, such that it creates steam bubbles in the pump. When these bubbles reach areas where the pressure rises, they suddenly implode. The implosion is accompanied by noise and, in cases where it occurs in the vicinity of a wall, it is likely to cause mechanical damage causing micro-perforations in the metal (erosion).

The other pumps used in the grey water management systems are the Venturi effect pumps. However, these Venturi effect pumps require the use of another type of pump for generating the driving pressure, which puts a strain on the weight of the assembly. Moreover, these pumps have very low energy efficiency, in the order of 10-25%, and are susceptible to cavitation.

The cavitation phenomena are highly disadvantageous for equipment “sensitive” to this phenomenon because they cause mechanical deterioration of the equipment, performance degradation, noise and in some cases creation of gas bubbles that may be problematic for the equipment.

There is therefore a real need for a grey water management system that is highly energy efficient, space saving, is not very bulky, requires less maintenance and is not sensitive to the cavitation phenomenon that is likely to occur depending on the flight conditions.

In addition, it also appears that the pumps used in the state of the art grey water management systems are more sensitive to grey water pollution. In the application in question, relating in particular to the grey water system in an aircraft, the said state of the art pumps are prone to clogging problems when the grey water to be pumped is very dirty or highly contaminated with foreign bodies and/or organic materials. The said pumps are highly sensitive to the size of the waste material or foreign bodies present in the grey water to be pumped.

### BRIEF SUMMARY

One of the objectives of the invention is therefore to overcome these disadvantages by proposing a method of draining grey water contained in a holding tank of a grey water management system in aircraft toilets that requires less maintenance and is neither sensitive to cavitation nor the amount and size of the waste material and foreign bodies likely to be present in the said grey water.

In order to resolve the aforementioned problems, a method of draining grey water contained in a holding tank of a grey water management system in aircraft toilets has been developed. This method is remarkable as it consists of draining the grey water through an undulating diaphragm pump comprising an inlet conduit connected to the said holding tank; the pump diaphragm is able to undulate, by way of actuating means, between two flanges for draining the said grey water present in the holding tank through the inlet conduit of the pump to a discharge conduit of the pump.

Similarly, the invention also aims to provide a grey water management system that requires reduced maintenance, and is not sensitive to cavitation.

Another objective of the invention is to provide a system for management of grey water that is not sensitive to the quantity and size of foreign material or waste that may be present in the said grey water.

For this, a system for management of grey water in aircraft toilets has been developed. The system comprises a washbasin, a water supply valve of the said basin, a grey water drainage system of the washbasin connected to a holding tank equipped with a filter, a bowl connected to the holding tank, and a main grey water tank. The bowl and the holding tank are connected to the said main tank by conduits.

According to the invention, the system for management of grey water comprises an undulating diaphragm pump consisting of an inlet conduit connected to the holding tank and a discharge conduit connected to the bowl. The pump diaphragm is able to undulate, by way of actuating means, between two flanges for draining the said grey water present in the holding tank through the inlet conduit of the pump to a discharge conduit of the pump for supplying grey water to the bowl.

In relation to the systems for management of grey water of the prior art, there is reduced maintenance due to the absence of moving parts in the membrane pump, and a high tolerance to cavitation and pollution. In addition, the installation of the system for management of grey water is facilitated since the diaphragm pump allows self-priming of the pump.

According to one of the ways in which this is possible, the actuating means of the diaphragm pump consist of an electromagnetic linear actuator and damping means that define the stroke of the electromagnetic actuator.

Preferably, the pump has a cylindrical body, defining a cylindrical chamber into which the inlet conduit and the discharge conduit open coaxially. The undulating diaphragm has a central aperture extending in line with the discharge conduit.

Thus, according to several alternative embodiments, the inlet conduit of the diaphragm pump extends either radially with respect to the pump case or on to the opposite side of the discharge conduit, coaxially to the latter.

Furthermore, the inlet conduit of the diaphragm pump is in the form of multiple vents created in the cylindrical pump case for connecting the cylindrical chamber and the external components of the pump.

Incidentally, the inlet conduit and/or discharge conduit of the diaphragm pump comprises at least one filter.

Favorably, the diaphragm pump of the system for management of grey water, according to the invention, comprises at least one sensor, such as a pressure sensor and/or a temperature sensor and/or a grey water sensor.

### BRIEF DESCRIPTION OF THE DRAWINGS

Other advantages and features will become clearer from the following description of several alternative embodiments, given as non-exhaustive examples, of the pump and system for management of grey water according to the invention, based on the accompanying drawings in which:

FIG. 1 is a schematic representation of the system for management of grey water according to the invention,

FIG. 2 is a side view of the first embodiment of the pump of the system for management of grey water according to the invention,

FIG. 3 is a side view of the second embodiment of the pump of the system for management of grey water according to the invention,

FIG. 4 is a side view of the third embodiment of the pump of the system for management of grey water according to the invention,

FIG. 5 is a graphical representation of the distribution of the particle sizes of the grey water, which are driven by the pump of the system for management of grey water according to the invention.

### DETAILED DESCRIPTION

In the following description of the system for management of grey water of an aircraft according to the invention, the numerical references correspond to the related description in all cases. Moreover, the different views are not necessarily drawn to scale.

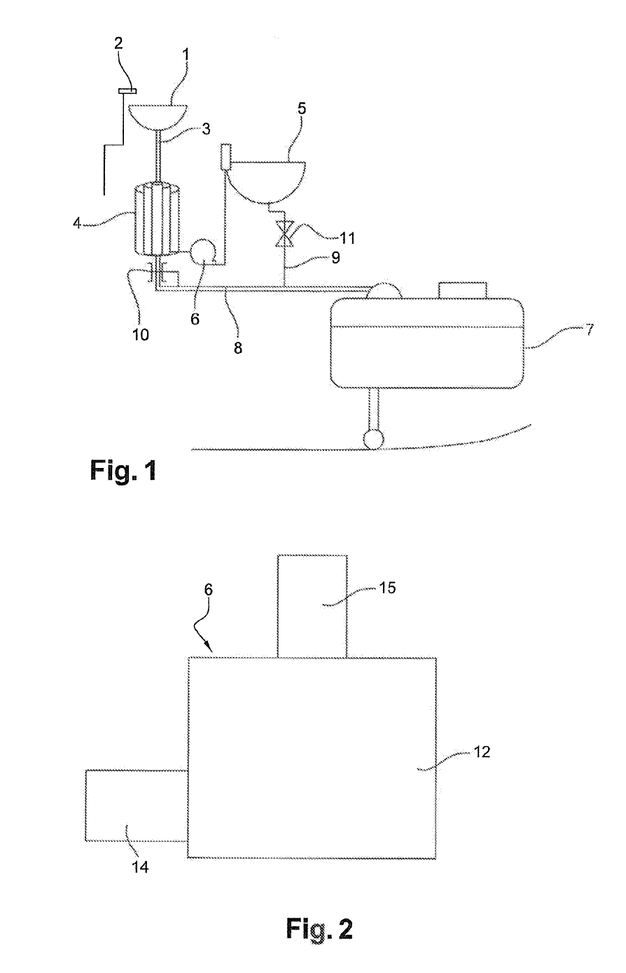

With reference to FIG. 1, the system for management of grey water comprises a washbasin 1, a water supply valve of the said basin 2, a grey water drainage system 3 of the washbasin connected to a holding tank 4, which is equipped with a filter, and a bowl 5 connected to the holding tank 4. The system also comprises a main grey water tank 7, the bowl 5 and the holding tank 4 are connected to the said main tank 7 by conduits 8, 9 each fitted with a valve 10 and a solenoid valve 11.

In conformity with the invention, the system comprises an undulating diaphragm pump 6 consisting of an inlet conduit 14 connected to the holding tank 4 and a discharge conduit 15 connected to the bowl 5. The diaphragm of the pump 6 is able to undulate, by way of actuating means, between two flanges for draining the said grey water present in the holding tank 4, through the inlet conduit 14 of the pump 6 to a discharge conduit 15 of the pump 6 for supplying grey water derived from the washbasin to the bowl 5.

With reference to FIGS. 2 to 4, the diaphragm pump 6 of the system for management of grey water comprises a cylindrical pump case 12 demarcating a cylindrical chamber into which an inlet conduit 14 and a discharge conduit 15 coaxial with the pump case 12 open, an undulating diaphragm having a central aperture and extending into the cylindrical chamber between a fixed lower flange and a fixed upper flange; the said flanges extend into the said cylindrical chamber.

The undulating diaphragm has the shape of a disc comprising a circular central aperture. The undulating diaphragm is obtained in a deformable material such as silicone elastomer or similar material for example. The thickness of the undulating diaphragm increases from its central portion to its peripheral edge, and the central circular aperture has a diameter that is noticeably equal to the inner diameter of the discharge conduit 15.

The lower flange is fixed to the bottom wall of the case 12 of the pump 6 and the upper flange is adapted to be moved vertically in order to vary the displacement of the pump as will be explained in detail later. Furthermore, the walls of the bottom and upper flanges provided for the diaphragm are convex.

In addition, the pump 6 comprises strong support means for the diaphragm between the upper and lower flanges. The said supporting means function along with the peripheral edge of the diaphragm. These supporting means consist, for example, of an annular ring supporting the peripheral edge of the diaphragm.

Furthermore, the pump 6 comprises actuating means for the undulating diaphragm working with the supporting means of the latter. The said actuating means consist of, for example, an electromagnetic linear actuator and damping means that define the stroke of the electromagnetic actuator.

The electromagnetic actuator in turn comprises a movable cylindrical ring which extends coaxially with the discharge conduit 15 above the upper flange and in line with the excitation motor. The excitation motor consists of an inner fixed cylindrical frame and an outer fixed cylindrical frame supporting an annular coil and a pair of annular permanent magnets each extending above and below the annular coil; the said ring coil is connected to a supply circuit. The power supply circuit includes, for example, at least one power amplifier and a signal generator.

The lower end of the movable cylindrical ring is secured to an annular ring equipped with a shoulder, and in engagement with a connecting component that is fixed to the support ring of the undulating diaphragm. Thus, the connecting component maintains the undulating diaphragm when the actuator is at rest.

Moreover, favorably, the upper flange is secured to a trolley adapted to slide vertically in relation to the inner fixed frame in order to vary the displacement of the said pump 6. The said trolley consists of, for example, a circular component having a central recess for the passage of the discharge conduit 15 and holes into which the fixed guides of the inner fixed frame extend. In order to vary the position of the said trolley, the latter comprises a threading functioning with a screw that extends into a hole created in the inner fixed frame. The screw consists of a tubular piece with a circular cross section having a thread on its outer wall, in its lower part.

The upper plate is secured to the underside of the said trolley so that, by varying the position of the said trolley along the vertical axis of revolution of the pump 6, it is possible to vary the displacement of the pump according to the requirement of the intended application.

Incidentally, the inlet conduit 14 and/or the discharge conduit 15 may comprise at least one filter.

Moreover, the pump according to the invention may comprise at least one sensor, such as a pressure sensor and/or a temperature sensor and/or a grey water sensor. The information measured by the sensors can be sent to the supply circuit, which may comprise management means for controlling the flow depending on the said information by modifying the supply characteristics of the electromagnetic linear actuator.

Thus, when the electromagnetic linear actuator is activated, the movable cylindrical ring is moved in an upward and downward direction, causing the undulating diaphragm to move in an upward and downward direction respectively at the frequency at which the linear electromagnetic actuator is supplied. In this manner, the diaphragm propagates a wave front which causes the grey water present in the cylindrical chamber to move to the discharge conduit 15.

In other words, the system for management of grey water includes a diaphragm pump 6 with positive displacement, which uses the diaphragm in reciprocation, wherein the grey water is displaced by trapping a fixed quantity, and by forcing the discharge of the trapped volume through the discharge conduit 15.

The diaphragm pump 6 therefore has good suction properties and can pump relatively dirty liquids with a relatively high amount of grain and solid content, including small objects that could fall into the washbasin 1 and be transported by the water, such as a piece of paper or a metal ring.

The only moving part that comes into contact with the grey water in the pump is the elastomeric membrane. All the mechanical and electrical components are isolated from exposure to the grey water. This minimizes the risk of trapping foreign bodies and maximizes the reliability of the grey water management system according to the invention.

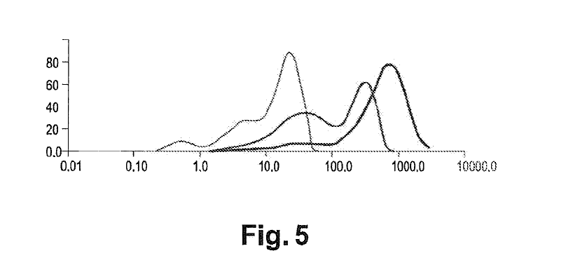

According to the invention, the grey water management system is not sensitive to the quantity and size of the waste or foreign bodies that may be present in the grey water, as shown in FIG. 5 illustrating a graph of the particle size distribution of the grey water driven by the pump of the system for management of grey water according to the invention.

Several alternative embodiments are possible for the arrangement of the inlet conduit 14 in relation to the case 12. According to a first embodiment illustrated in FIG. 2, the inlet conduit 14 of the diaphragm pump 6 extends radially in relation to the pump case 6.

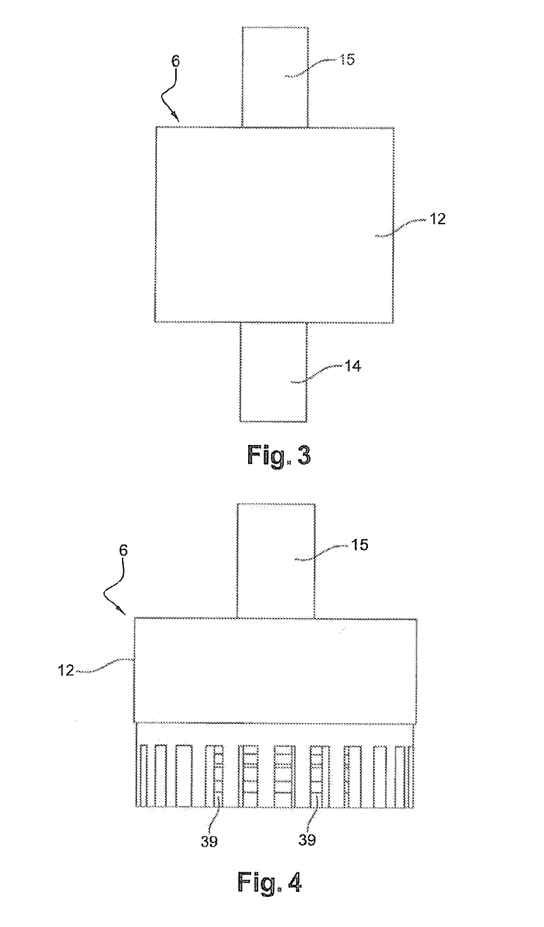

In the second embodiment illustrated in FIG. 3, the inlet conduit 14 extends from the opposite side of the discharge conduit 15, coaxially with the latter.

Furthermore, according to a third embodiment shown in FIG. 4, the inlet conduit 14 of the diaphragm pump 6 is in the form of multiple vents 39 created in the cylindrical pump 6 case 12 for connecting the cylindrical chamber and the external components of the pump 6. In this particular embodiment, the said vents 39 consist of longitudinal slots distributed uniformly over the circumference of the cylindrical pump case 12 and extend over the entire height of the cylindrical chamber.

It goes without saying that the shape of the pump does not limit the invention; the said pump case 12, the chamber and the diaphragm can have any shape, such as a parallelepiped shape for the pump case 12 and the chamber, and a rectangular shape for the diaphragm without being inconsistent with the scope of the invention. The key lies in the advantageous use of a diaphragm pump in the management of grey water from aircraft toilets.

Finally, it is obvious that the examples we have just given are only specific illustrations and in no way exhaustive with regard to the scope of the invention.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of draining grey water contained in a holding tank of a system for management of grey water in aircraft toilets, comprising: draining the grey water through an undulating diaphragm pump comprising an inlet conduit connected to the holding tank, the pump diaphragm being able to undulate between two flanges for draining the said grey water present in the holding tank through the inlet conduit of the pump to a discharge conduit of the pump.

2. A system for management of grey water in aircraft toilets, comprising a washbasin, a water supply valve of the said basin, a grey water drainage system of the washbasin connected to a holding tank, which is equipped with a filter, and a bowl connected to the holding tank, and a main grey water tank, the bowl and the holding tank being connected to the said main tank by conduits, wherein the system comprises an undulating diaphragm pump having an inlet conduit connected to the holding tank and a discharge conduit connected to the bowl, the pump diaphragm being adapted to undulate, by way of actuating means, between two flanges for draining the said grey water present in the holding tank through the inlet conduit of the pump to the discharge conduit of the pump in order to supply grey water to the bowl.

3. The system for management of grey water according to claim 2, wherein the actuating means of the diaphragm pump consist of an electromagnetic linear actuator and damping means that define the stroke of the electromagnetic actuator.

4. The system for management of grey water according to claim 2, wherein the pump has a cylindrical case, defining a cylindrical chamber into which the inlet conduit and the coaxial discharge conduit open; the undulating diaphragm comprises a central aperture that extends directly in line with the discharge conduit.

5. The system for management of grey water according to claim 4, wherein the inlet conduit of the diaphragm pump extends radially in relation to the pump case.

6. The system for management of grey water according to claim 4, wherein the inlet conduit of the diaphragm pump extends from the opposite side of the discharge conduit, coaxially in relation to the latter.

7. The system for management of grey water according to claim 4, wherein the inlet conduit of the diaphragm pump is in the form of multiple vents created in the cylindrical pump case for connecting the cylindrical chamber and the external components of the pump.

8. The system for management of grey water according to claim 2, wherein the inlet conduit and/or the discharge conduit of the diaphragm pump contains at least one filter.

9. The system for management of grey water according to claim 2, wherein the diaphragm pump comprises at least one sensor, such as a pressure sensor and/or a temperature sensor and/or a grey water sensor.

10. A system for management of grey water in aircraft toilets, comprising: a diaphragm pump having an inlet conduit connected to a holding tank and a discharge conduit connected to a bowl, the diaphragm pump being selectively undulated between two flanges for draining grey water present in the holding tank through the inlet conduit to the discharge conduit of the diaphragm pump to supply grey water to the bowl.

11. The system for management of grey water according to claim 10 further comprising an electromagnetic linear actuator and wherein the diaphragm pump is undulated by the electromagnetic linear actuator.
